(19) United States
(12) Patent Application Publication
(10) Pub. No.: US 2020/0042929 A1
(43) Pub. Date: Feb. 6, 2020

(54) Management System for Home Consumables

(71) Applicant: Chao-Cheng YU, Taoyuan City (TW)

(72) Inventor: Chao-Cheng YU, Taoyuan City (TW)

(21) Appl. No.: 16/049,994

(22) Filed: Jul. 31, 2018

(51) Int. Cl. G06Q 10/08; G06K 19/07; G06K 19/06; H04B 5/00; H04W 4/12

(52) U.S. Cl. CPC G06Q 10/087; G06K 19/0723; G06K 19/06037; G06K 2007/10524; H04W 4/12; H04B 5/0062; G06K 2019/06253; H04B 5/0031

(57) ABSTRACT

A management system for home consumables is disclosed, comprising a sticker component which has a sticker body including an NFC circuit, at least a handheld device including a reminder software unit as well as a cloud server equipment, wherein an activation label is placed at the position where the sticker body covers the release paper, and the reminder software unit can determine whether the NFC data transferred by the sticker body is identical to the contents of the activation label; if yes, it is possible to build an NFC device configuration file by means of the reminder software unit and upload the resulted NFC device configuration file to the cloud server equipment, then in case that the cloud server equipment determines the configured time for replacing or cleaning the consumables in the home device is up, it can automatically push a message to the handheld device.

### BACKGROUND OF THE INVENTION

### 1. Field of the Invention

The present invention generally relates to a management system for home consumables; in particular, it relates to surveillance, control and alert functions on home consumables by means of an NFC sticker along with mobile phone software.

### 2. Description of Related Art

The well-known “NFC” represents the abbreviation for “Near Field Communication” indicating a type of wireless technology initially proposed by the Philips Company and promoted collaboratively by Nokia and several other major companies in relevant fields in the year 2003, and, afterwards, many enterprises, universities and customers jointed to establish a pan-Europe alliance for this technology. The NFC is characterized in the non-contact RFID (Radio Frequency Identification) which applies a single chip in combination with a sensor card reader, a sensor card as well as the point-to-point function, and operates at a certain frequency range within a short distance.

Therefore, the NFC allows information communications between a mobile phone and other NFC devices, such as mobile phones, NFC labels and payment devices such that, through this NFC mechanism, data can be successfully shared between devices having the NFC circuit and mobile phones.

Also, due to the feature of low price in NFC, the present application would be an optimal solution if it is possible to utilize an NFC sticker in combination with a home device, further conjunctively with a mobile phone software, and to monitor and control required regular consumables replacement or cleansing process time limits, and also to enable notifications concerning relevant time limits via the mobile phone software as they expire, so the users can be reminded of performing these replacement or regular cleansing operations thereby that the users need not to worry about oblivion problems which probably make them forget to replace the consumables or miss these cleaning jobs for too long time.

### SUMMARY OF THE INVENTION

A management system for home consumables according to the present invention, comprising: a sticker component, including a release paper and a sticker body, in which the release paper has an activation label covered by the sticker body, and the sticker body has an NFC circuit, and the sticker body is to be attached onto a home device requiring regular consumable replacements or cleaning processes; at least a handheld device, including a reminder software unit performing connections to a cloud server equipment, in which the reminder software unit comprises: an interface management module, used to provide at least an operation interface; an identification authentication module, connected to the interface management module and used to input or scan at least an activation label on the operation interface, and, after scanning the sticker body by means of the handheld device, capable of acquiring the NFC data transferred by the NFC circuit, so that the identification authentication module can determine whether the NFC data is identical to the contents of the activation label; a device basic setup module, connected to the interface management module and the identification authentication module, which, after the identification authentication module determining that the NFC data is identical to the contents of the activation label, is able to input at least a basic setup data on the operation interface; an alarm time limit setup module, connected to the interface management module and the device basic setup module, and used to input or select at least an alarm time limit data; an alarm approach setup module, connected to the interface management module and the device basic setup module, and used to input or select at least an alarm approach data; an alarm mode setup module, connected to the interface management module and the device basic setup module, and used to input or select at least an alarm mode data; a device file creation upload module, connected to the basic setup module, the alarm time limit setup module, the alarm approach setup module and the alarm mode setup module, and capable of building an NFC device configuration file by means of the basic setup data, the alarm time limit data, the alarm approach data and the alarm mode data and then uploading the NFC device configuration file; a cloud server equipment, performing connections with the reminder software unit and comprising: a storage unit, used to receive and store at least an NFC device configuration file which includes at least the basic setup data, the alarm time limit data, the alarm approach data and the alarm mode data; a time limit determination unit, connected to the storage unit and used to determine whether it is time to replace or clean the consumable in the home device in accordance with the alarm time limit data; and a message alarm unit, connected to the time limit determination unit, and configured to send a replacement or cleaning message to the handheld device if the configured time has expired.

In a preferred embodiment, the handheld device may be a smartphone or a tablet computer.

In a preferred embodiment, the activation label may be a symbol label or a barcode label.

In a preferred embodiment, the symbol label is a combination of characters, symbols and/or numbers.

In a preferred embodiment, the barcode label is a QR Code.

In a preferred embodiment, the message alarm unit can transfer the message about replacing or cleaning the consumable to the handheld device by way of mobile phone messaging or else via email deliveries.

### BRIEF DESCRIPTION OF THE DRAWINGS

FIG. 1 shows an integral architecture view of the management system for home consumables according to the present invention;

FIG. 2 shows an architecture view of the reminder software unit in the management system for home consumables according to the present invention;

FIG. 3 shows an architecture view of the cloud server apparatus in the management system for home consumables according to the present invention;

FIG. 4A shows a view of the sticker component in the management system for home consumables according to the present invention;

FIG. 4B shows an implementation view of the sticker component, lifted to exhibit the activation label, in the management system for home consumables according to the present invention;

FIG. 4C shows another implementation view of the sticker component, lifted to exhibit the activation label, in the management system for home consumables according to the present invention;

FIG. 5 shows a flowchart for adding a device in the management system for home consumables according to the present invention;

FIG. 6A shows an implementation view for adding a device in the management system for home consumables according to the present invention;

FIG. 6B shows an implementation view for adding a device in the management system for home consumables according to the present invention;

FIG. 6C shows an implementation view for adding a device in the management system for home consumables according to the present invention;

FIG. 6D shows an implementation view for adding a device in the management system for home consumables according to the present invention;

FIG. 6E shows an implementation view for adding a device in the management system for home consumables according to the present invention;

FIG. 6F shows an implementation view for adding a device in the management system for home consumables according to the present invention;

FIG. 7 shows an implementation view for using the sticker body in the management system for home consumables according to the present invention.

FIG. 8 shows a flowchart of performing time limit determination and pushing processes in the management system for home consumables according to the present invention.

### DETAILED DESCRIPTION OF THE PREFERRED EMBODIMENTS

Other technical contents, aspects and effects in relation to the present invention can be clearly appreciated through the detailed descriptions concerning the preferred embodiments of the present invention in conjunction with the appended drawings.

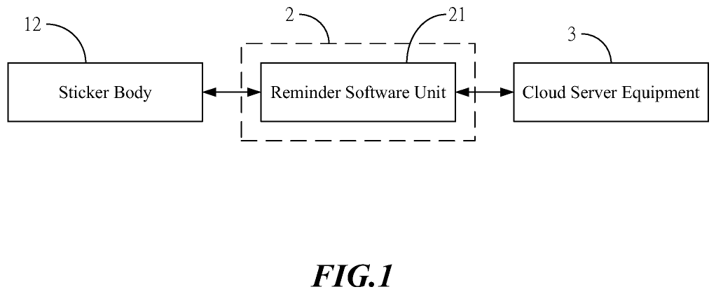

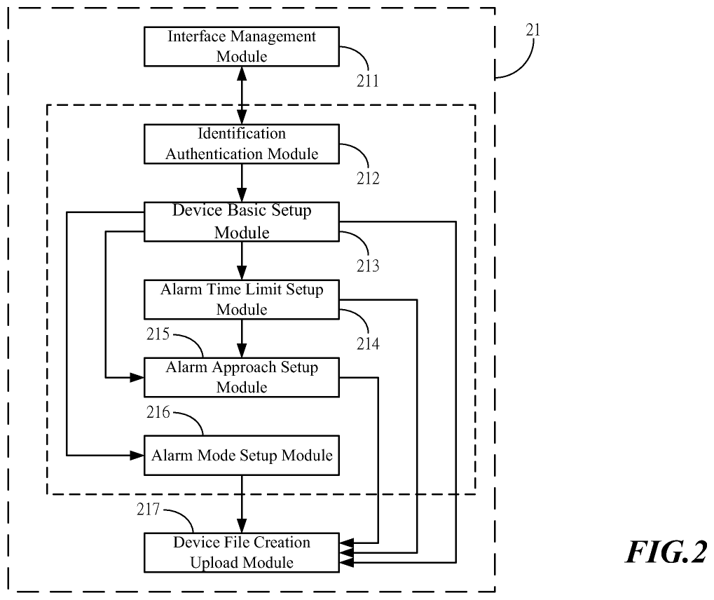

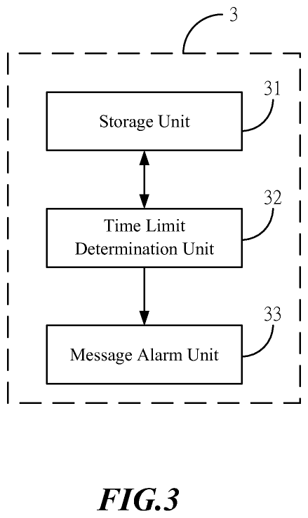

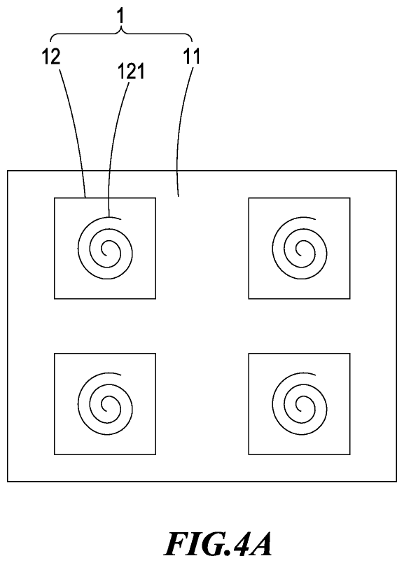

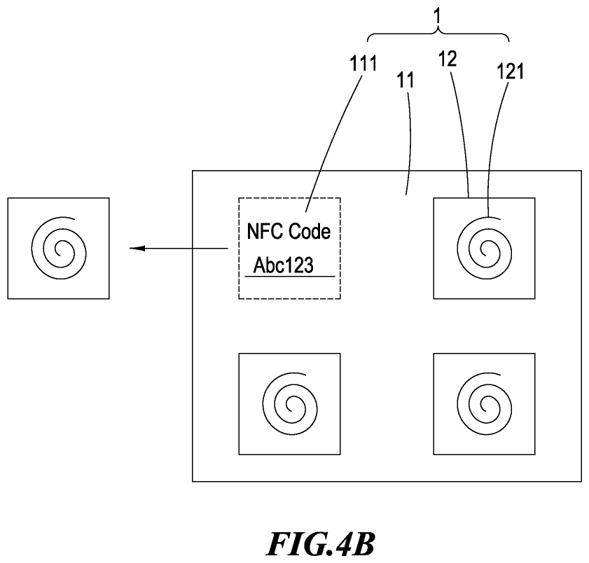

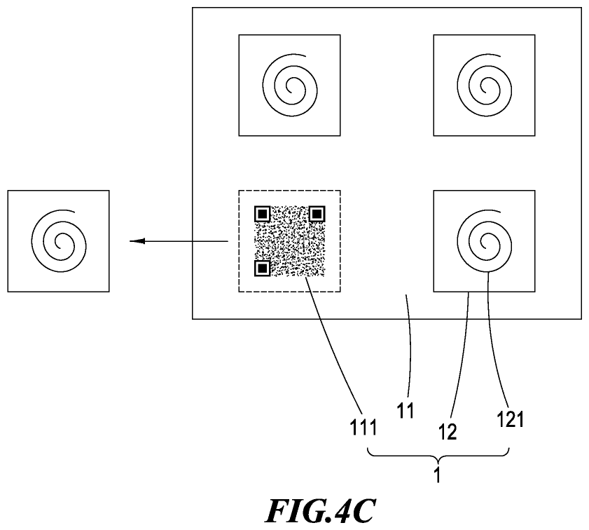

Refer first to FIGS. 1, 2, 3, 4A, 4B and 4C, wherein the management system for home consumables according to the present invention are respectively shown. It can be seen from the Figures that the present invention essentially comprises a sticker component 1, a handheld device 2 and a cloud server equipment 3, wherein, as shown in FIG. 4A, the sticker component 1 includes a release paper 11 and a sticker body 12 attached onto the release paper 11, and also, as shown in FIG. 4B, the release paper 11 has an activation label 111 which may be a symbol label (e.g., a combination of characters, symbols and/or numbers) or otherwise a barcode label (e.g., a QR Code or 2-dimension barcode); herein the activation label 111 is covered by the sticker body 12 and can be seen only when the sticker body 12 is taken away, and the sticker body 12 includes an NFC circuit 121 and multiple sticker bodies 12 may be attached onto the release paper 12; in addition, as shown in FIG. 4C, the activation label 111 revealed under the removed sticker body 12 is a QR Code.

Also, the handheld device 2 includes a reminder software unit 21 and may be a smartphone or a tablet computer, and the reminder software unit includes an interface management module 211, an identification authentication module 212, a device basic setup module 213, an alarm time limit setup module 214, an alarm approach setup module 215, an alarm mode setup module 216 and a device file creation upload module 217, wherein the interface management module 211 is used to provide at least an operation interface, while the identification authentication module 212 used to input or scan at least an activation label via the above-said operation interface and, after scanning the sticker body 12 with the handheld device 2, allow to acquire the NFC data transferred by the NFC circuit, such that the identification authentication module 212 can determine whether the obtained NFC data is identical to the contents included in the activation label 111.

Herein, in case that the identification authentication module 212 determines the NFC data is identical to the contents of the activation label 111, the device basic setup module 213 can input at least one basic setup data on the operation interface.

Moreover, the alarm time limit setup module 214 can be used to input or select at least an alarm time limit data, the alarm approach setup module 215 to input or select at least an alarm approach data, and the alarm mode setup module 216 to input or select at least an alarm mode data.

Further, herein the device file creation upload module 217 can be utilized to build an NFC device configuration file with the aforementioned basic setup data, alarm time limit data, alarm approach data and alarm mode data, and then upload the resulted NFC device configuration file to the cloud server apparatus 3.

Meanwhile, the cloud server apparatus 3 comprises a storage unit 31, a time limit determination unit 32 and a message alarm unit 33, in which the storage unit 31 can be used to receive and store at least an NFC device configuration file including such basic setup data, alarm time limit data, alarm approach data and alarm mode data.

Herein the time limit determination unit 32 can be used to determine whether it is time to replace or clean the consumables in the home device based on the alarm time limit data. If yes, then the message alarm unit 33 will automatically push a mobile phone message or deliver an email to notify the handheld device 2; in case it goes through emails, then, in addition to the handheld device 2, other devices capable of reading emails can be applied to receive such messages as well.

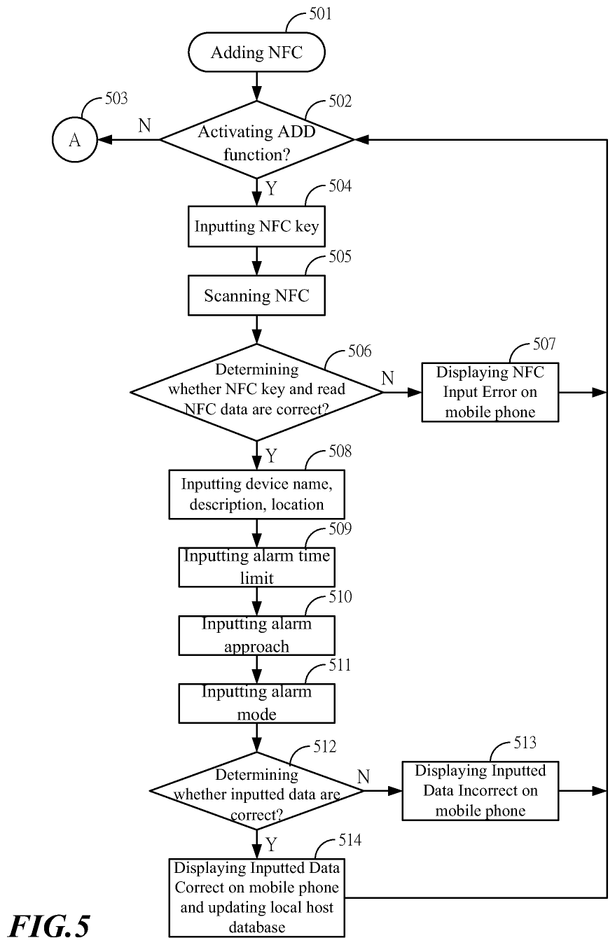

Upon adding a new device, the process thereof can be shown in FIG. 5, comprising the following steps:

(1) To add an NFC device (501), first determining whether the Add function is activated or not (502); if determined NO, proceeding to another process (A 503); if determined YES, prompting to input the NFC key (activation label) (504);

(2) afterwards, rescanning the sticker body in order to acquire the NFC data transferred on the NFC circuit (505), then determining whether the NFC data and the contents of the activation label are identical (506); if determined NO, displaying responses, e.g., “Input Error” and so forth, on the operation interface of the reminder software unit (507);

(3) on the other hand, if determining YES, i.e., the NFC data and the contents of the activation label are identical, then starting inputting contents such as the device name, device descriptions and device location (508), and subsequently the alarm time limit (509), alarm approach (510) and alarm mode (511);

(4) finally, determining whether the entered data is correct (512); if NO, displaying responses such as “Incorrect input data” etc. on the operation interface of the reminder software unit (513); however, if YES, then displaying responses such as “Correct input data” etc. on the operation interface of the reminder software unit and updating the local host database (data stored in the reminder software unit) (514).

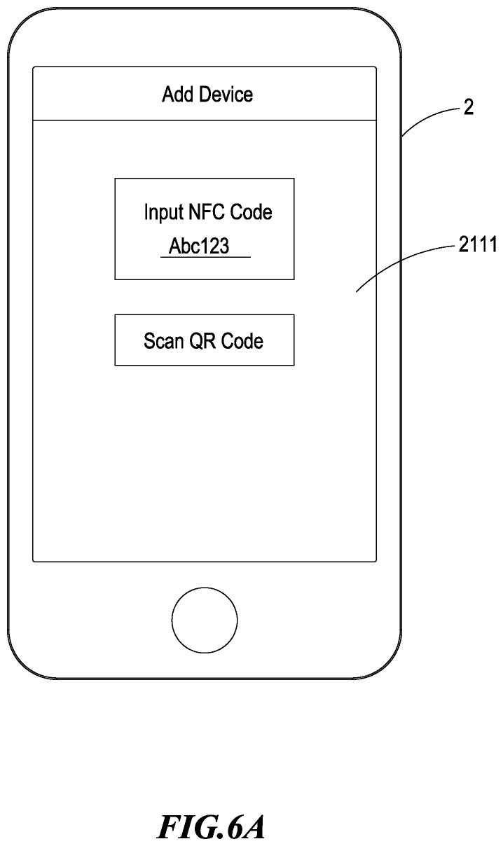

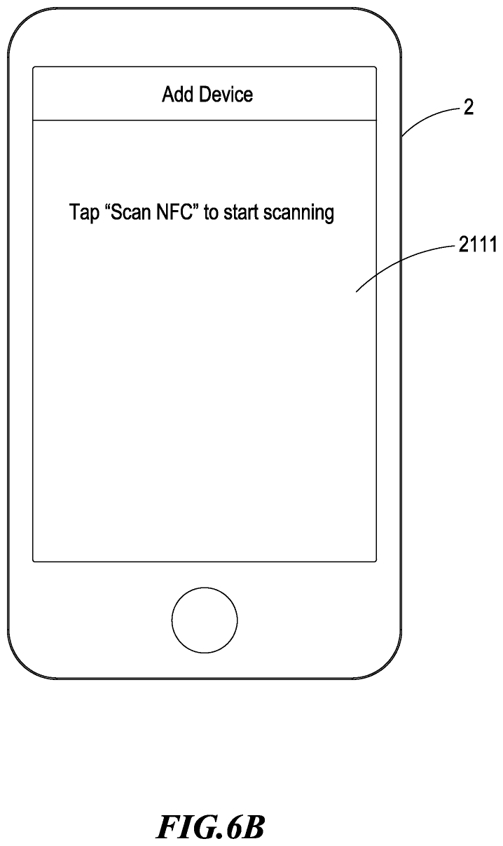

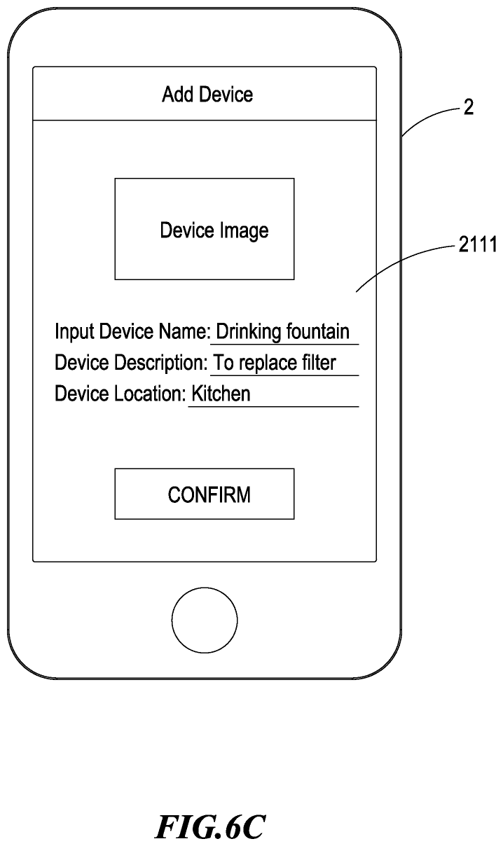

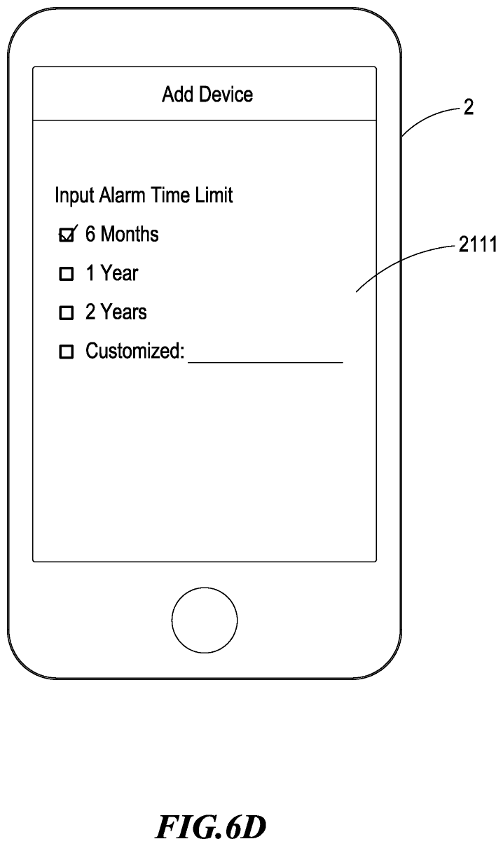

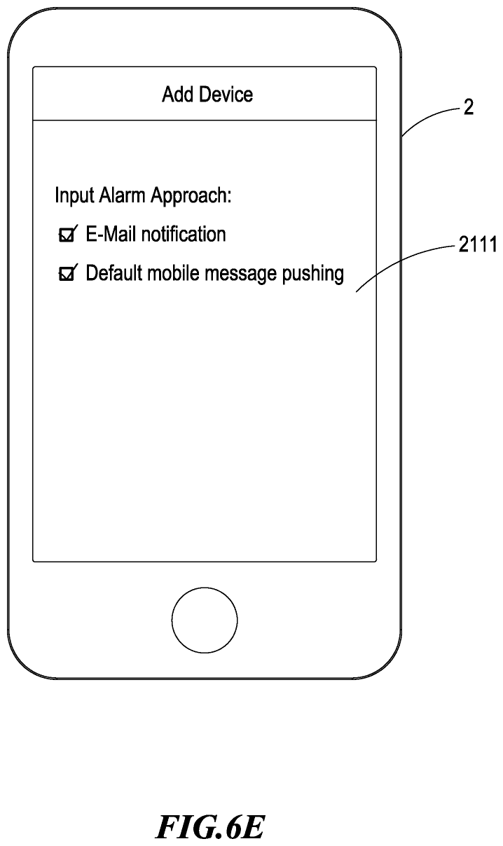

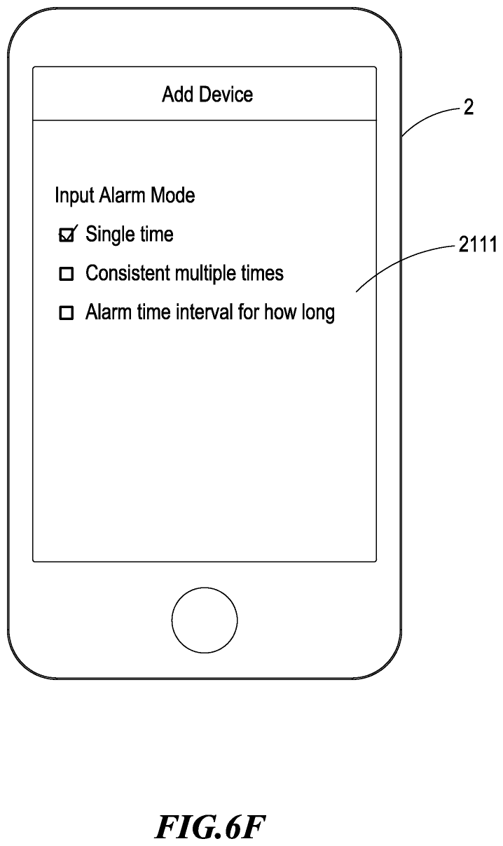

Meanwhile, as shown in FIGS. 6A-6B, the operation 2111 of the reminder software unit 21 allows the user to first input or scan the activation label, and then prompt to scan the sticker body, thereby acquiring the NFC data transferred on the NFC circuit and subsequently determining whether the NFC data is identical to the contents of the activation label.

In case they are identical, as shown in FIGS. 6C-6F, the user is allowed to input the basic setup data (its data may further include image or video data), alarm time limit data, alarm approach data, alarm mode data, in which the alarm approach data may be mobile phone push or email delivery, and after completing the setup process, it is possible to build such basic setup data, alarm time limit data, alarm approach data and alarm mode data into an NFC device configuration file and upload the resulted file to the cloud server equipment 3.

Additionally, in addition to uploading the resulted NFC device configuration file to the cloud server equipment 3, the reminder software unit 21 also archives it so that the user may also open the configuration file to edit the contents thereof, and then uploads the modified configuration again thereby replacing the previous configuration file.

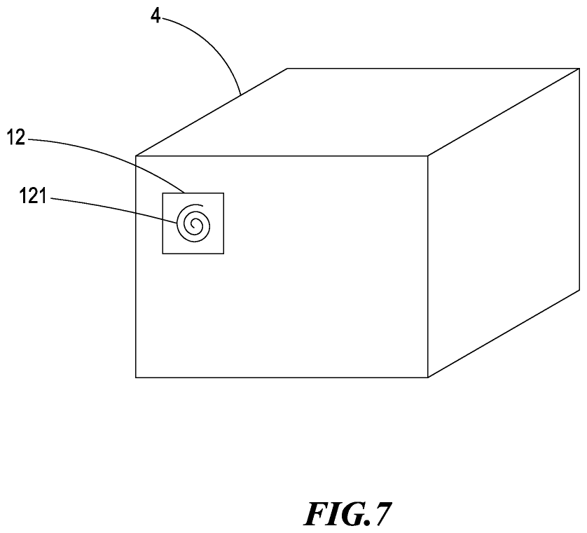

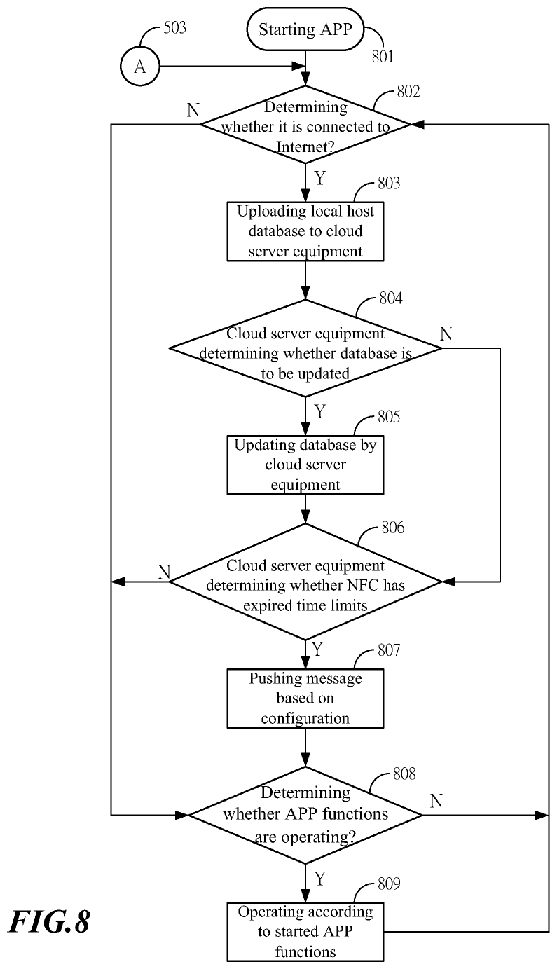

Furthermore, as shown in FIG. 7, when the user attaches the sticker body 12 onto a consumable of a home device 4, it is possible to perform surveillance and control on alarm time limits by means of the reminder software unit 21, comprising the following control steps shown in FIG. 8:

(1) after opening the APP (801), first determining whether it is connected to the Internet (802), and the process (503) shown in FIG. 5 also proceeding to determine whether it is connected to the Internet (802); if determined NO, then determining whether the reminder software unit has process (808) required to be performed; if determined NO, then returning to the process determining whether it is connected to the Internet;

(2) if determined to be connected to the Internet, uploading the local host database (i.e., the configuration file) to the cloud server equipment (803), and subsequently the cloud server equipment determines whether the local host database (i.e., the configuration file) is updated (804); if determined NO, determining whether the setup time has expired (806); and if YES for updating, then updating the data originally stored in the cloud server equipment (805), and the cloud server equipment determines whether the setup time has expired (806);

(3) following this, if the setup time is determined to be “Not Expired”, then proceeding to STEP (808); whereas, in case the setup time is determined to be “Expired”, then performing message pushing in accordance with the configuration (807);

(4) finally, proceeding to STEP (808), i.e., determining whether the message push function has been performed; if determined NO, returning to STEP (802); otherwise, if determined YES, then starting APP function to perform (809), and subsequently returning to STEP (802) for repeated operations after completion.

In comparison with other conventional technologies, the management system for home consumables according to the present invention provides the following advantages:

1. The present invention allows to apply an NFC sticker in combination with a home device, further conjunctively with a mobile phone software, thereby monitoring and controlling the time limits for regular consumable replacements or cleaning processes, and, upon such time limits expiring, notifying the expiration of such time limits via the mobile phone software so as to remind the user of replacing or cleansing the consumables.

2. Moreover, since the present invention can remind the user of performing the replacements of consumables in a home device or regular cleaning processes (e.g., changing the filter of a water purifier or washing the filter screens of an air conditioner, etc.), the user needs not to worry about possible oblivion issues which may potentially make the user forget to replace the consumables or regularly wash them for too long time.

It should be noticed that, although the present invention has been disclosed through the detailed descriptions of the aforementioned embodiments, such illustrations are by no means used to restrict the scope of the present invention; that is, skilled ones in relevant fields of the present invention can certainly devise any applicable alternations and modifications after having comprehended the aforementioned technical characteristics and embodiments of the present invention without departing from the spirit and scope thereof. Hence, the scope of the present invention to be protected under patent laws should be delineated in accordance with the claims set forth hereunder in the present specification.

What is claimed is:

1. A management system for home consumables, comprising:
a sticker component, including a release paper and a sticker body, in which the release paper has an activation label covered by the sticker body, and the sticker body has an NFC circuit, and the sticker body is to be attached onto a home device requiring regular consumable replacements or cleaning processes;
at least a handheld device, including a reminder software unit performing connections to a cloud server equipment, in which the reminder software unit comprises:
an interface management module, used to provide at least an operation interface;
an identification authentication module, connected to the interface management module and used to input or scan at least an activation label on the operation interface, and, after scanning the sticker body by means of the handheld device, capable of acquiring the NFC data transferred by the NFC circuit, so that the identification authentication module can determine whether the NFC data is identical to the contents of the activation label;
a device basic setup module, connected to the interface management module and the identification authentication module, which, after the identification authentication module determining that the NFC data is identical to the contents of the activation label, is able to input at least a basic setup data on the operation interface;
an alarm time limit setup module, connected to the interface management module and the device basic setup module, and used to input or select at least an alarm time limit data;
an alarm approach setup module, connected to the interface management module and the device basic setup module, and used to input or select at least an alarm approach data;
an alarm mode setup module, connected to the interface management module and the device basic setup module, and used to input or select at least an alarm mode data;
a device file creation upload module, connected to the basic setup module, the alarm time limit setup module, the alarm approach setup module and the alarm mode setup module, and capable of building an NFC device configuration file by means of the basic setup data, the alarm time limit data, the alarm approach data and the alarm mode data and then uploading the NFC device configuration file;
a cloud server equipment, performing connections with the reminder software unit and comprising:
a storage unit, used to receive and store at least an NFC device configuration file which includes at least the basic setup data, the alarm time limit data, the alarm approach data and the alarm mode data;
a time limit determination unit, connected to the storage unit and used to determine whether it is time to replace or clean the consumable in the home device in accordance with the alarm time limit data; and
a message alarm unit, connected to the time limit determination unit, and configured to send a replacement or cleaning message to the handheld device if the configured time has expired.

2. The management system for home consumables according to claim 1, wherein the handheld device is a smartphone or a tablet computer.

3. The management system for home consumables according to claim 1, wherein the activation label is a symbol label or a barcode label.

4. The management system for home consumables according to claim 3, wherein the symbol label is a combination of characters, symbols and/or numbers.

5. The management system for home consumables according to claim 3, wherein the barcode label is a QR Code.

6. The management system for home consumables according to claim 1, wherein the basic setup data is a text data, image data and/or audio data.

7. The management system for home consumables according to claim 1, wherein the message alarm unit can transfer the message about replacing or cleaning the consumable to the handheld device by way of mobile phone messaging or else via email deliveries.
